(19) United States
(12) Patent Application Publication
(10) Pub. No.: US 2003/0035408 A1
(43) Pub. Date: Feb. 20, 2003

(54) Redundant communication adapter system for connecting a client to an FDDI network

(76) Inventor: James E. Hebert, Fairport, NY (US)

Correspondence Address: McCormick, Paulding & Huber LLP, City Place II, 185 Asylum Street, Hartford, CT, 06103-3402, US

(21) Appl. No.: 09/932,553

(22) Filed: Aug. 17, 2001

(51) Int. Cl. H04L 12/28; H04L 12/56

(52) U.S. Cl. 370/349; 370/394

(57) ABSTRACT

A communications adapter system having a server, a pair of redundant I/O boards, a pair of redundant network interface cards and a pair of redundant switches. A software program monitors the system for failures, and is typically stored in the memory of the server. The system is fully redundant and can check connectivity from the server to a remote network device. The system can also run on FDDI systems.

### FIELD OF THE INVENTION

The present invention relates to communication adapter systems for connecting a client to a ring network. More specifically, the present invention relates to a communication adapter system for connecting a client to an FDDI network, which has a fully redundant network architecture designed to eliminate all major network single points of failure.

### BACKGROUND OF THE INVENTION

The Internet is a network of networks linked by several layers of protocols. It uses the Internet Protocol (IP) to route digital packets of information across a multiplicity of networks and communications media in an efficient and generally reliable manner. Transmission and receipt of entire messages between two points on the network is managed by the Transmission Control Protocol (TCP), which uses IP packets of bits and guarantees orderly delivery of the bits in the message (TCP/IP).

The physical layer of the Internet connects users to telephone, satellite, and cable TV networks, i.e. communications networks. Users utilize a client to communicate with the Internet or other private or public communications networks. Typically a client is a software application running on a personal computer or workstation that relies on a server to perform some operations.

Communication adapter systems (or adapters) are the hardware and software that provide the interface between a client and the communication network, e.g. the Internet, another public network or a private network. By far the most common adapters used today are those that interface systems to the telephone, Ethernet, FDDI (Fiber Distributed Data Interface), Token Ring or ATM (Asynchonous Transfer Mode) networks. Although adapters for other types of networks are also available. A Communication adapter system will typically include a software application running on a server, Input/Output (I/O) boards, Network Interface Cards (NIC), switches and the necessary cabling required to provide connectivity to the network.

Networks can be characterized as local area networks (LANs), metropolitan area networks (MANs), or wide area networks (WANs). As their names imply, the first two are usually limited to a geographical area that extends no more than a few miles between the extremities. Because of the smaller distances involved, LANs usually operate at relatively high speeds of between 10 and 1000 Mbps. The Ethernet and the Fiber Distributed Data Interface (FDDI) are examples of commonly used LAN technologies. WANs can cover distances of hundreds or thousands of miles and, in general, include a plurality of LANs and/or MANs. The WANs typically utilize a variety of transmission media leased from common carriers.

The Ethernet is a widely used LAN protocol, which uses a bus or a star topology and supports data transfer rates of typically 10 Mbps. The Ethernet physical and lower software levels are defined in the IEEE 802.3 standard. Ethernet uses the CSMA/CD access method to handle simultaneous demands. A newer version of Ethernet, called 100 Base-T (or Fast Ethernet), supports data transfer rates of 100 Mbps. Additionally an even newer version, Gigabit Ethernet, supports data rates of 1000 Mbps (1 gigabit per second).

FDDI systems utilize a set of ANSI protocols for sending digital data over a fiber optic cable. FDDI networks are token-passing networks and support data rate of up to 100 Mbps per second. FDDI networks are typically used on MANs and as backbones for WANs. A version of FDDI, called FDDI-II, supports the transmission of voice and video information as well as data. Another version of FDDI, called FDDI Full Duplex Technology (FFDT), uses the same network infrastructure but can potentially support data rates up to 200 Mbps.

As users become more reliant on networks and a Client-Server based model of distributed computing, preventing failures which cause the loss of mission-critical data or services from a network becomes increasingly important. This is especially true of today's clients running large applications such as Enterprise Resource Planning (ERP), SAP, PeopleSoft, Baan, Data Warehousing and Internet Services. Therefore, network architectures, such as an FDDI system, typically include intrinsic redundancies in order to maintain network connectivity, i.e., the ability to maintain data transfer and communicate with a client, even if a network device should fail.

The nature of these large applications demands that there is minimal downtime and maximum network connectivity for the systems upon which they run. Many large application users measure the cost of an extended outage in the six-figure or higher range. This does not include less tangible costs such as those associated with a user losing an internet customer forever.

However, an existing single point of failure (SPOF) mode, i.e., a non-redundant failure mode, in many networking systems today can be the communication adapter system which connects a client to the network itself. This SPOF could be from a failed network interface card (NIC), a system bus (Sbus) card, bad cable connections, damaged cables, bad switch ports or cards, the loss of an entire switch or router, or even human error. Though these failures statistically do not occur frequently, when they do the effects can be severe and widespread.

One prior art communication adapter system which addresses this problem is the High Availability Network (HAnet) system, designed by Sun Microsystems. The HAnet system is a communication adapter system, which provides a fully redundant architecture and was designed to run on an Ethernet system. The HAnet system includes a primary I/O board connected to a Client's server. The I/O board has a primary Network Interface Card (NIC) mounted thereon. The primary NIC is, in turn, connected to a primary switch for transferring data between the Client and the Ethernet. A fully redundant passive system having a passive I/O board, NIC and switch is also connected to the server.

An HAnet software program runs on the server and utilizes a UNIX system command called “ndd” queries the primary NIC to determine connectivity, i.e., existence of an electrical signal, between the server and NIC. If connectivity is detected, than the HAnet system performs a “Failover Operation”, which deactivates the active components and activates the redundant passive components of the communications adapter system.

However, the HAnet system was only designed to run on Ethernet systems and not on FDDI systems. Moreover, the HAnet system could only test connectivity up to the NIC and could not query the switch or any other remote device on the network. Accordingly, the switch could fail and the HAnet system would not detect it, because it had no capability to go beyond the NIC layer.

Additionally, ndd is a UNIX command, but not all device drivers on an NIC will support ndd queries. In particular typical device drivers for the FDDI NIC do not have this capability.

Accordingly, there is a need for an improved communication adapter system that is fully redundant and can check connectivity from the Client server to a remote network device, and additionally run on FDDI systems.

### SUMMARY OF THE INVENTION

The present invention offers advantages and alternatives over the prior art by providing a communications adapter system having a server, a pair of redundant I/O boards, a pair of redundant network interface cards and a pair of redundant switches. A software program monitors the system for failures, and is typically stored in the memory of the server. The system is fully redundant and can check connectivity from the server to a remote network device. The system can also run on FDDI systems.

These and other advantages are accomplished in an exemplary embodiment of the invention by providing a communication adapter system for connecting a client to a network. The system includes a server having a memory electrically connected to the client. A primary I/O board is electrically connected to the server and has a primary network interface card (NIC). The primary NIC has a primary I/O port for connecting to the network. The primary NIC is configured to enable active transfer of data from the client to the network through the primary I/O port. A secondary I/O board is electrically connected to the server and has a secondary NIC. The secondary NIC has a secondary I/O port for connecting to the network. The secondary NIC is configured to disable active transfer of data from the client to the network though the secondary I/O port. A primary switch is electrically connected to the primary I/O port and the network. A secondary switch is electrically connected to the secondary I/O port and the network. Program signals are stored in the memory of the server and define an executable program. The program includes the steps of:

generating a connectivity signal to the primary I/O switch to test connectivity at least from the primary I/O board to the primary switch;

monitoring the primary I/O port to detect a response signal within a predetermined time period after the generation of the connectivity signal;

configuring the primary NIC to disable active transfer of data if the response signal is not detected within the time period; and

configuring the secondary NIC to enable the active transfer of data if the response signal is not detected within the time period.

In an alternative embodiment of the invention, the program includes generating a connectivity signal to a remote device on the network to test connectivity from the primary I/O board through the primary switch and to the remote device.

In other alternative embodiments of the invention the system may be for an FDDI network. Additionally, the connectivity signal may be a ping signal.

### BRIEF DESCRIPTION OF THE DRAWINGS

FIG. 1 is a schematic block diagram of an exemplary embodiment of a communication adapter system in accordance with the present invention; and

FIG. 2 is a flow diagram of the High Availability Network software utilized in the communication adapter system of FIG. 1.

### DETAILED DESCRIPTION OF THE PREFERRED EMBODIMENTS

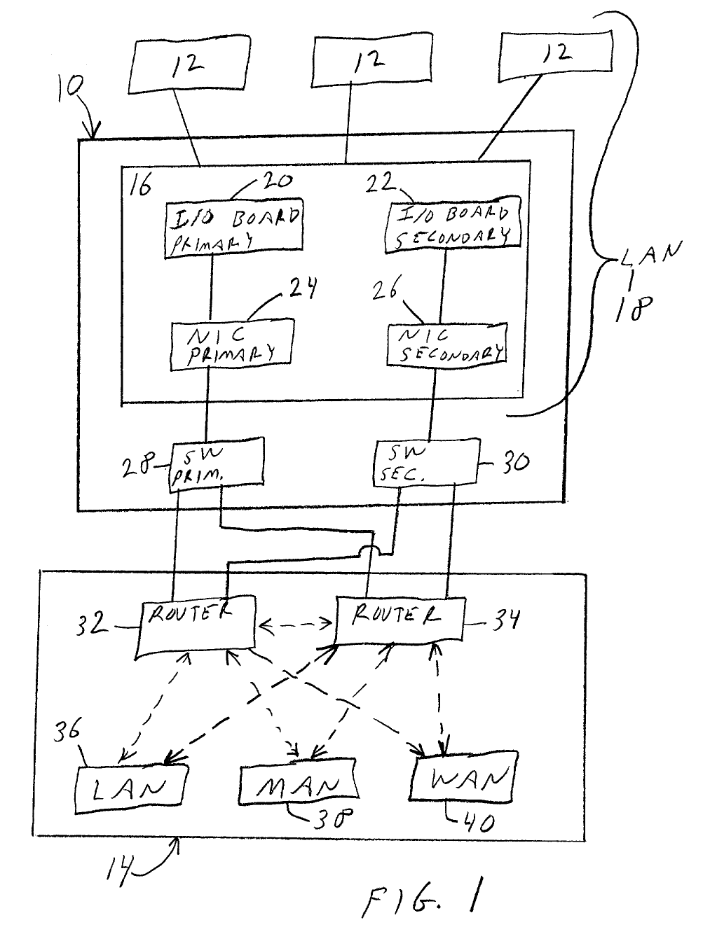

Referring to FIG. 1, an exemplary embodiment of a communication adapter system in accordance with the present invention is shown generally at 10. The system 10 provides the interface between a set of clients 12 and an FDDI communications network 14, e.g., a local FDDI MAN network which forms a portion of the Internet.

The clients 12 are typically an application that runs on a personal computer, workstation, mainframe or the like, which rely on a server 16 to perform some operations. Clients 12 run the gamut from fat clients-computers that run most programs from their own hard drives, and use a minimum of network services—to inexpensive thin clients that may have no hard drive at all. They run programs and graphics using their own microprocessor but depend entirely on a server 16 to run programs and store data files. A dumb terminal is a monitor, keyboard, and the bare minimum of hardware needed to connect them to the network. It uses the server's 12 microprocessor to perform all functions.

The server 16 is typically a computer or device on a network that manages network resources. For example, a file server is a computer and storage device dedicated to storing files. Any user on a network can store files on the server. A print server is a computer that manages one or more printers, and a network server is a computer that manages network traffic. A database server is a computer system that processes database queries.

Servers are often dedicated, meaning that they perform no other tasks besides their server tasks. On multiprocessing operating systems, however, a single computer can execute several programs at once. A server in this case could refer to the program that is managing resources rather than the entire computer.

Some servers specialize in functions other than passing out files. A print server allows everyone on a network share a printer. The printer can be attached to a computer on the network; some printers designed for network without a host PC. Other specialized servers provide shared access to the Internet, banks of CD-ROM drives, and tape backup. Some servers specialize in running programs that are designed for a network-wide use, such as an e-mail or database server.

The clients 12 and the server 16 make up a Local Area Network (LAN) 18. A local area network (LAN) is made up of nodes, which are usually two or more computers in the same building that are linked together with wires or radio signals so that files can move among the computers. LAN 18 is a client-server network. In a client-server network, one central computer is the file server. The server contains programs and data files that can be assessed by other computers in the network. Servers are often faster and more powerful than personal computers, running a network operating system, or NOS, such as Windows NT, Unix, Linux, or Novell NetWare. A NOS manages the movement of files and the network's security by maintaining lists of users, their passwords, and the drives and directories for which a user has been given access privileges. Server 16 is also called a host computer.

The communications adapter system 10 includes the server 16, a pair of I/O boards 20, 22, a pair of FDDI network interface cards (NIC) 24, 26, a pair of switches 28, 30, and the interconnecting wiring. A software program, in this exemplary case the latest FDDI version of HAnet from Sun Microsystems, is required to run and monitor the system 10 for failures, and is typically stored in the memory of the server 16.

I/O board 20 is primary and I/O board 22 is secondary. That is I/O board 20 is actively transferring data from the LAN 18 to the network 14 and back. The I/O board 22 is passive in that it is acting as backup in case of a failure and will be activated when a failure on I/O board 20 is sensed.

Each client 12 and server 16 on server-based network 18 makes a connection through the FDDI network interface cards (NIC) 24, 26. The NIC 24 is the primary NIC and is actively transferring data. The NIC 26 is the secondary NIC utilized for redundancy.

In general an NIC is an expansion board you insert into a computer so the computer can be connected to a network. Most NICs are designed for a particular type of network, protocol, and media, although some can serve multiple networks. The most common types of NIC are Ethernet cards and FDDI cards. For portable computers, the NIC may be in the form of a PC Card. Network connections can also be rigged through a serial port or universal serial port.

Switch 28 is a primary FDDI switch and switch 30 is a secondary FDDI switch. As in the case of NICs 24 and 26, the switch 28 is actively transferring data, while switch 30 provides redundancy in case switch 28 should fail.

A switch in a network is a device that filters and forwards packets between LAN segments. Switches operate at the data link layer (layer 2) of the OSI Reference Model and therefore support any packet protocol. LANs that use switches to join segments are called switched LANs or, in the case of Ethernet networks, switched Ethernet LANs.

Switches in general allow any two mutually exclusive devices on the switch to communicate with each other at full speed. Switches can be designed for various network configurations, e.g., FDDI, Ethernet and ATM. Although switches are more expensive than simple hubs, they increase the total bandwidth of the network. So-called edge-switches support local switching and provide a higher-speed interface to the network backbone.

The switches 28 and 30 provide redundant connection to the FDDI network 14. In this case through a pair of redundant routers 32 and 34, which than provide connectivity to the rest of the network which can be made up of various LANs 36, MANs 38 and WANs 40.

A router is a device that connects two LANs. Routers are generally used to interconnect a wide range of different local area network architectures (Ethernet, FDDI, ATM, etc.), and to provide connectivity to wide area networks such as WAN 40. They use routing tables and routing protocols to gain knowledge of the entire network, discover network topology changes, provide rerouting if necessary, minimize hop count, and choose routes that minimize congestion. Many routers can be configured to perform both bridging and routing functions, in which case they are called brouters, which is short for bridging routers.

The FDDI HAnet software runs on the server 16 and utilizes a “ping” system command to detect failures between the server 16 and the primary switch 24, or between the server 16 and the network 14 through a network device such as router 32.

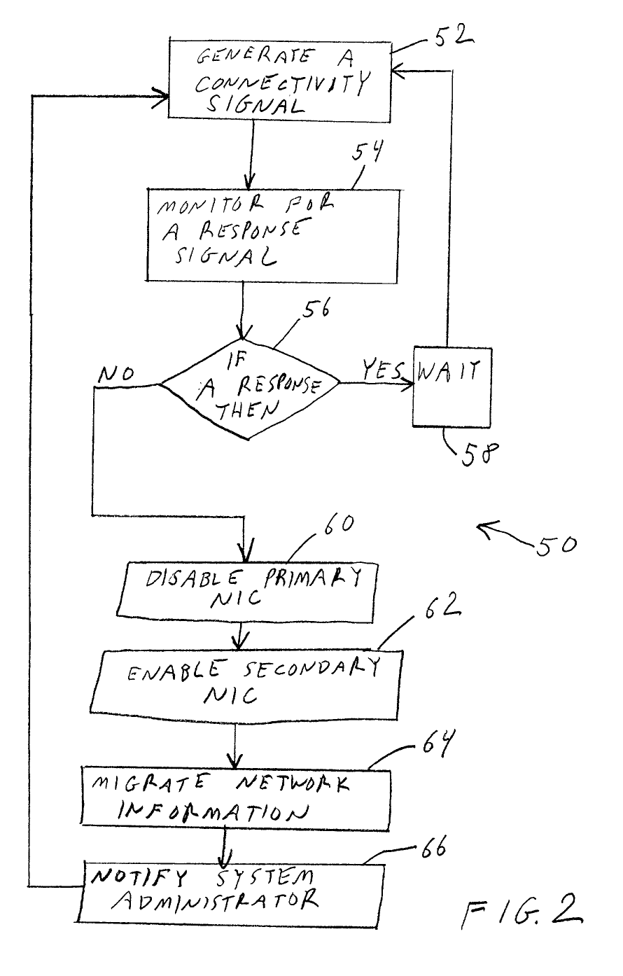

Referring to FIG. 2, a general flow diagram of the FDDI HAnet software is shown generally at 50. In block 52, the HAnet software utilizes a ping command to generate a connectivity signal to a remote network device, such as router 32, through an I/O port of the primary I/O board 20.

The ping application can communicate with a peripheral or remote system or device. The ping signal sends packets (message bits) to a specific IP address or destination device. The device receives the request and sends back a reply.

In block 54, the software monitors the primary I/O port of I/O board 20 for a response signal from the remote device for a predetermined period of time. In, block 56, if a response signal is detected, than connectivity to the remote device is established and the program steps to block 58 where the program waits a specified period of time before cycling back to block 52 to regenerate another connectivity signal. The number of re-entries and the amount of time between the generation of a signal (a request) may be specified or programmably adjusted.

If no response is received the system proceeds to block 60, where it configures the primary NIC 24 to disable the active transfer of data from the client to the network through the primary I/O board 20. In block 62 the system configures the secondary NIC 26 to enable transfer of data from the client to the network through the primary I/O board 22.

In block 64, the system transfers network information from the primary 24 to the secondary 26 NIC. For example, some of the network information to be transferred includes: IP addresses, netmasks, broadcasts, and logical IP addresses.

The system than, as indicated in block 66, notifies the system administrators by various methods, e.g., e-mail, a display on a console or a custom post-failover command. The system than steps back to block 52 to begin again.

Prior art redundant communication adapter systems could only test connectivity between the I/O board and the NIC. The prior art had no capability to go beyond the NIC layer. By distinct contrast the present invention could test connectivity to the switches at least (one step beyond the NIC connections). Additionally the present invention can also test much further in that it can communicate to peripheral or remote systems or devices on the network.

Though the connectivity signal in this embodiment utilized a “ping” command, one skilled in the art would recognize that other connectivity command signals may also be used, e.g., snoop, traceroute, spray, netstat or rsh.

Though this embodiment describes a communication adapter system for an FDDI system, other systems are within the scope of this invention as well, e.g., Ethernet or ATM.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A communication adapter system for connecting a client to a network, the system comprising:
a server having a memory electrically connected to the client;
a primary I/O board electrically connected to the server and having a primary network interface card (NIC), the primary NIC having a primary I/O port for connecting to the network, the primary NIC configured to enable active transfer of data from the client to the network through the primary I/O port;
a secondary I/O board electrically connected to the server and having a secondary NIC, the secondary NIC having a secondary I/O port for connecting to the network, the secondary NIC configured to disable active transfer of data from the client to the network though the secondary I/O port;
a primary switch electrically connected to the primary I/O port and the network;
a secondary switch electrically connected to the secondary I/O port and the network; and
program signals stored in the memory of the server and defining an executable program for:
generating a connectivity signal to the primary I/O switch to test connectivity at least from the primary I/O board to the primary switch;
monitoring the primary I/O port to detect a response signal within a predetermined time period after the generation of the connectivity signal;
configuring the primary NIC to disable active transfer of data if the response signal is not detected within the time period; and
configuring the secondary NIC to enable the active transfer of data if the response signal is not detected within the time period.

2. The system of claim 1 wherein the network is an FDDI network.

3. The system of claim 1 wherein the program comprises generating a connectivity signal to a remote device on the network to test connectivity from the primary I/O board through the primary switch and to the remote device.

4. The system of claim 1 wherein the connectivity signal is a ping signal.

5. The system of claim 1 wherein the program comprises transferring network information from the primary NIC to the secondary NIC.

6. The system of claim 5 wherein the network information includes one of an IP address, a netmask, a broadcast, and a logical IP address.

7. The system of claim 1 wherein the program comprises notifying a systems administrator of a failure.

8. A method for detecting failures in a communication adapter system for connecting a client to a network, the method comprising:
generating a connectivity signal from a primary I/O board of the system to a primary switch of the system to test connectivity at least from the primary I/O board to the primary switch;
monitoring a primary I/O port of the primary I/O board to detect a response signal within a predetermined time period after the generation of the connectivity signal;
configuring a primary NIC of the primary I/O board to disable active transfer of data from the client to the network through the primary I/O port if the response signal is not detected within the time period; and
configuring a secondary NIC of a secondary I/O board of the system to enable the active transfer of data from the client to the network through a secondary I/O port of the secondary I/O board if the response signal is not detected within the time period.

9. The method of claim 8 wherein the network is an FDDI network.

10. The method of claim 8 wherein generating includes generating a connectivity signal to a remote device on the network to test connectivity from the primary I/O board through the primary switch and to the remote device.

11. The method of claim 8 wherein generating includes generating a ping signal.

12. The method of claim 8 comprising transferring network information from the primary NIC to the secondary NIC.

13. The method of claim 12 wherein transferring includes transferring one of an IP address, a netmask, a broadcast, and a logical IP address.

14. The method of claim 8 comprising notifying a systems administrator of a failure.
